(19) United States
(12) Patent Application Publication
(10) Pub. No.: US 2003/0206644 A1
(43) Pub. Date: Nov. 6, 2003

(54) Identification and individual recognition system

(76) Inventor: Anthony D. Kurtz, Ridgewood, NJ (US)

Correspondence Address: DUANE MORRIS LLP, 100 COLLEGE ROAD WEST, SUITE 100, PRINCETON, NJ, 08540-6604, US

(21) Appl. No.: 10/195,255

(22) Filed: Jul. 15, 2002

Related U.S. Application Data
(60) Provisional application No. 60/377,873, filed on May 3, 2002.

(51) Int. Cl. G06K 9/00

(52) U.S. Cl. 382/115

(57) ABSTRACT

There is disclosed an embedded chip which contains data indicative of a person, which chip is embedded on the body of a person and therefore cannot easily be removed. In any event, the chip contains data, which is intimately associated with the individual, such as the individual's voice print, retina scan, fingerprint, ear print or heart sounds. The chip can also include data concerning the name of the person and other pertinent data, such as social security numbers, personal medical data and so on. The fact that the chip is embedded enables it to be scanned by many devices and therefore, to obtain a visual or other read-out of the person's identification indicia, such as the voiceprint or retina scan and so on. The actual, the physical indicia is compared with the stored indicia on the chip. This is done by a computer using a comparison algorithm or some other data comparator which is quite well known. If the data compares, then a positive identity of the person has been made.

### PRIORITY FILING

This application claims the benefit of the earlier filing date, under 35 U.S.C. 119, of commonly owned provisional patent application, serial No. 60/377,873 entitled “Identification and Individual Recognition System,” filed on May 3, 2002 and assigned to the assignee herein.

### FIELD OF INVENTION

This invention relates to personal identification systems, and more particularly, to such a system which incorporates a module embedded beneath the skin of an individual which contains information pertinent to a unique characteristic of that individual.

### BACKGROUND OF THE INVENTION

As one can ascertain, the ability of recognizing individuals based on DNA or other features is widespread. In fact, there has been talk of providing a universal card for every citizen of the United States which would contain all pertinent information about the person. The card would include a photograph of the person, maybe a replica of the person's fingerprints and so on. Such cards are capable of being manipulated. For example, a photograph can be removed and another photograph can be put in its place, counterfeit cards can be made almost in any particular manner. Therefore, to provide a totally secure system is a very expensive and difficult task. There are also suggestions that an individual can be provided with a chip or module which would be implanted on the person of the body using a biocompatible material. The implanted chip could contain indicia regarding the person. There has been proposed utilizing an embedded chip which has a person's DNA programmed on the chip so that the person's DNA can be recognized. In any event, as one can ascertain, such identification techniques are extremely expensive due to the fact that to perform a DNA survey takes time and is an expensive procedure compared to many other procedures. It is therefore an object of the present invention to provide an identification system which contains information pertinent to the individual and which can be quickly and economically checked in the presence of the person. The present identification system is economical and simple to monitor.

### SUMMARY OF INVENTION

There is disclosed an embedded chip which contains data indicative of a person, which chip is embedded on the body of a person and therefore cannot easily be removed. In any event, the chip contains data, which is intimately associated with the individual, such as the individual's voice print, retina scan, fingerprint, ear print or heart sounds. The chip can also include data concerning the name of the person and other pertinent data, such as social security numbers, personal medical data and so on. The fact that the chip is embedded enables it to be scanned by many devices and therefore, to obtain a visual or other read-out of the person's identification indicia, such as the voice print or retina scan and so on. The actual, the physical indicia is compared with the stored indicia on the chip. This is done by a computer using a comparison algorithm or some other data comparator which is quite well known. If the data compares, then a positive identity of the person has been made.

### BRIEF DESCRIPTION OF THE FIGURES

FIG. 1 is a pictorial depicting a chip embedded in the arm or other body part of a person.

FIG. 2 is a front view of a chip containing typical data pertinent to identification purposes of this invention.

FIG. 3 is a block diagram of a validation identification utilizing a biocompatible chip according to this invention.

FIG. 4 is still another implementation of validation of identification utilizing a remote database.

FIG. 5 is a typical example of an embedded biocompatible chip depicting various techniques of storing the information.

### DETAILED DESCRIPTION OF THE FIGURES

Referring to FIG. 1, there is shown a pictorial depicting the arm of typical person with a biocompatible chip as 10 or 11 located beneath the person's skin and close to the surface. Biocompatible materials are very well known and many materials are totally and completely compatible with human tissue, whereby the insertion of such a biocompatible material will not cause the body to reject the material. Examples of such materials are stainless steel, tantalum, semiconductor materials and other materials. In any event, positioned on the chip is identification data associated with the person, which is taken directly from the person. The identification data, unlike DNA, would consist of data indicative of the person's voice print, a retina scan, fingerprint, ear print, heart sounds or combinations of the above.

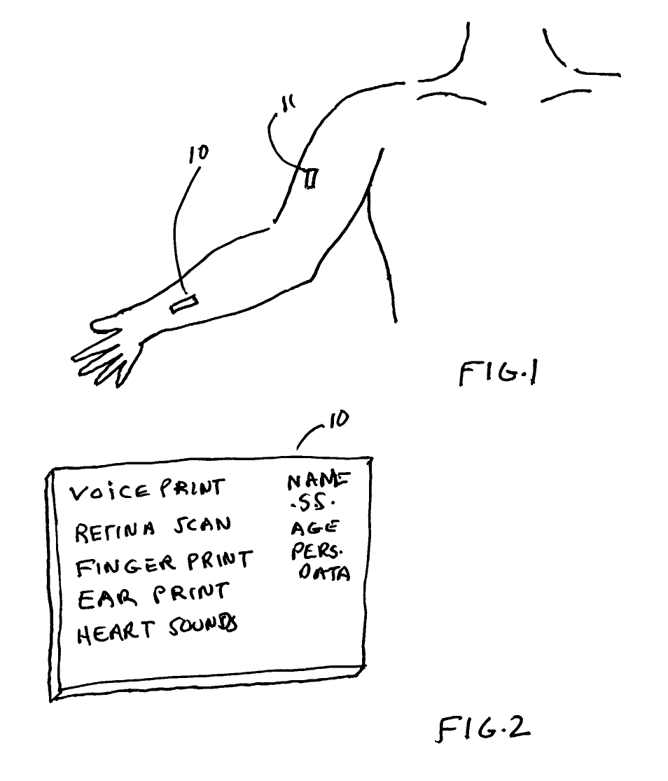

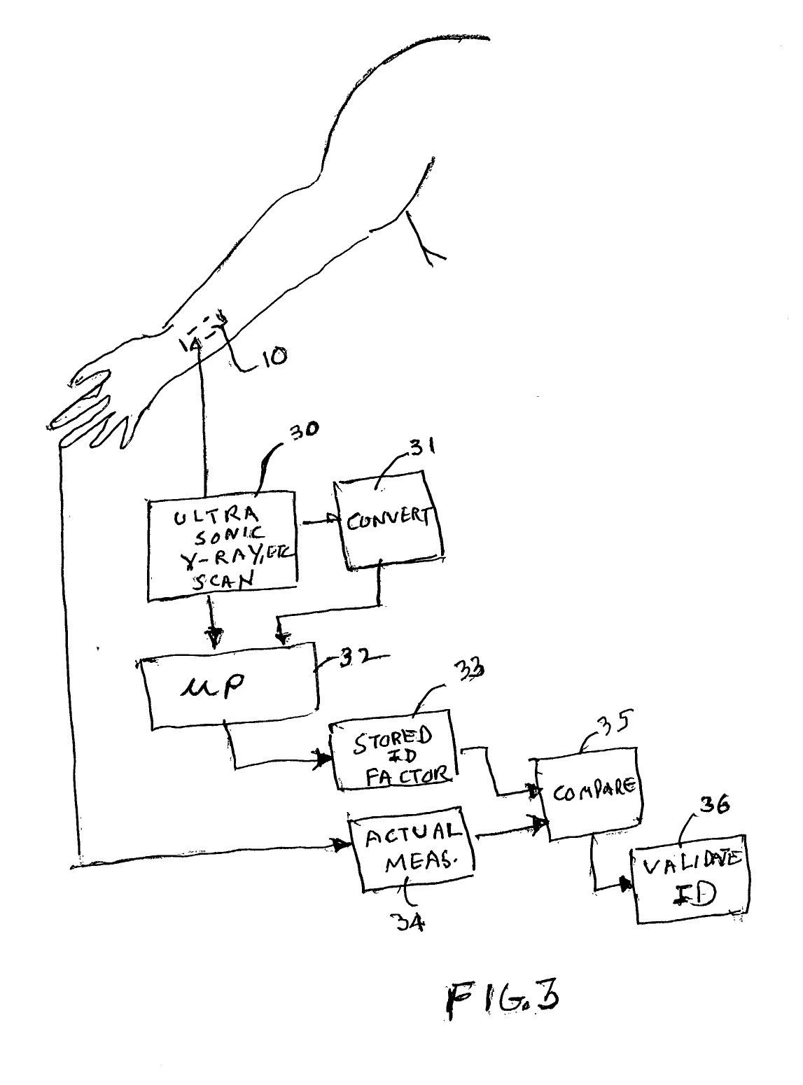

The imprinted chip, as shown in FIG. 2, may also contain the person's name, social security number, age in regard to birth date, personal data, such as illnesses and so on. The data can be scanned by conventional scanning means, such as infrared, ultrasonic scanners and so on to retrieve the information stored on the chip. Essentially, as one can ascertain, the information on the chip is indicative of information that is only available from the associated person, such as the voice print, a retina scan or a person's fingerprint. In this manner, the chip 10, once embedded, will contain, for example, the exact fingerprint of the person who has the chip embedded on his person. Therefore, a security check point facility can access the chip and retrieve an analog presentation (picture) of the fingerprint and compare the fingerprint with the person's actual fingerprint. In this manner, there is no way that the person's identity can be compromised. It is, of course, understood that even a photograph is not accurate enough to verify the identity of the person who is carrying the photograph. Various photographs can be retouched and they can be replaced. The embedded chip cannot be replaced because a replacement of the chip would not contain data compatible with the person carrying the data.

It is also understood that more than one type of data can be carried on the chip 10. For example, a chip can have a voice print where the person is now interrogated to speak, say four or five given words, and the given words are the voice print on the chip. The chip is thus scanned and the histograms of the stored voice print are then compared with the actual voice print by a computer comparison technique and security would therefore know that this voice belongs to this person. This can be associated together with the fingerprint or, for example, an ear print or heart sounds of the person.

The whole aspect of the above-noted invention is to make the detection process as simple as possible and as rapid as possible. One can also understand that one can analyze characteristics of people by various other techniques, such as DNA strands, blood samples or other techniques which can be invasive. However, these techniques are much more complicated in regard to preparing accurate data and comparing the data. The techniques described herein, such as voice prints, retina scans, finger prints, ear prints and heart sounds can be implemented by very simple comparison techniques and then automatically and rapidly verified.

The data stored on the chip can be typical digital data as pixels or other data capable of producing an electronic presentation of the individual's voice print or retina scan, and then an automatic computer comparator or optical system can compare the voice print or retina scan or other data embedded on the chip 10 and 11 with the actual physical data obtained from the person. This way one can assure that the data belongs to that particular person because it is regenerated by the person at the security station.

Referring to FIG. 3 there is shown a block diagram of one example of a system which utilized the data stored on a chip to determine the physical identity of the person on a real-time basis. Referring to FIG. 3, there is again shown, the embedded chip 10. While the chip is shown embedded in the forearm of an individual, it is also ascertained that the chip can be embedded anywhere on an individual's person, including different areas of the arm, on the leg, on the ankle and so on and so forth. The system is preferably utilized for security in identifying humans. It is also understood that the system can be used for identifying animals, such as thoroughbred horses, cattle and so on. As indicated, the chip as embedded contains predetermined physical information regarding the identity of the individual. This information is eventually going to be compared with the actual information derived directly from the individual to ascertain the true identity of the person. It is, of course, understood that there are not too many ways of circumventing the present identification scheme. The reason for this is that the embedded chip can only relate to the physical qualifications of the person carrying it. Therefore, if a chip is substituted the person who retains the substituted chip will not have the fingerprints or the retina scan or the ear print or any of the other characteristics which have been described in conjunction with FIG. 2. Thus, according to this invention and as shown in FIG. 3, when a person's identity is to be ascertained, the embedded chip 10 is scanned by ultrasonic, x-ray, NMR or some other conventional scanning mechanism. This is depicted by module 30. As indicated, the word “scanned” includes taking an actual physical photograph or x-ray of the area where the chip is located. The x-ray or ultrasound will present a pictorial depiction of all data on the chip and therefore, the chip can be scanned or otherwise processed by a converter 31 which operates with regard to the particular data format on the chip.

In any event, the scanned chip 10 and the data emanating from the chip as converted by converter 31 is directed to a microprocessor 32. The microprocessor 32 processes the data to convert all the data into the requisite format. This format may be a fingerprint, a retina scan and so on and this is produced by the microprocessor, which then takes the stored ID factors on the chip 10 and processes them in a conventional way as depicted by module 33. For example, the data on the chip may now be presented as an actual fingerprint display or a sound display indicative of the person's heartbeats or a retina scan indicative of a person's retina or voice prints where the person has been enrolled in the system by asking to repeat various predetermined words. These words are now stored in forms of histograms or other formats and the histograms are now compared with the person's actual voice. Thus, as shown in FIG. 3, if the fingerprint of the person's middle finger were stored on the card, then the actual fingerprint is captured by conventional means located at the place where identification is to take place. This is determined by module 34 which is the actual measurement. If is, of course, understood that there are numerous ways of obtaining a person's fingerprint. If the information were a voiceprint, as indicated above, then the person would be requested to speak the predetermined words and these words would be processed by ordinary speech processing equipment and compared with the histogram stored on the embedded chip. If it was heart sounds, then the heart sounds would be stored and then the heart sounds of the person as actually present would be compared with the stored heart sounds. If it were an ear print and so on, then the proper comparisons would be done.

Essentially, as seen, the stored identification factor, as stored module in 33 and as processed as indicated above is, in fact, compared with the actual measurement obtained directly from the individual. This is done by a comparison or utilizing a comparator 35. It is well known how to compare such signals. In any event, if the comparison is within a predetermined range, for example about 90%. It would be indicated this is a valid identification and therefore the person would be validated as being identified because of the fact that the stored ID factor matched with the actual measured factor. The person would be validated, as seen in module 36. Validation can be indicated by many methods, including a display and so on. If there is not a comparison, then the person cannot be validated and would not obtain access to the desired premises or location and so on.

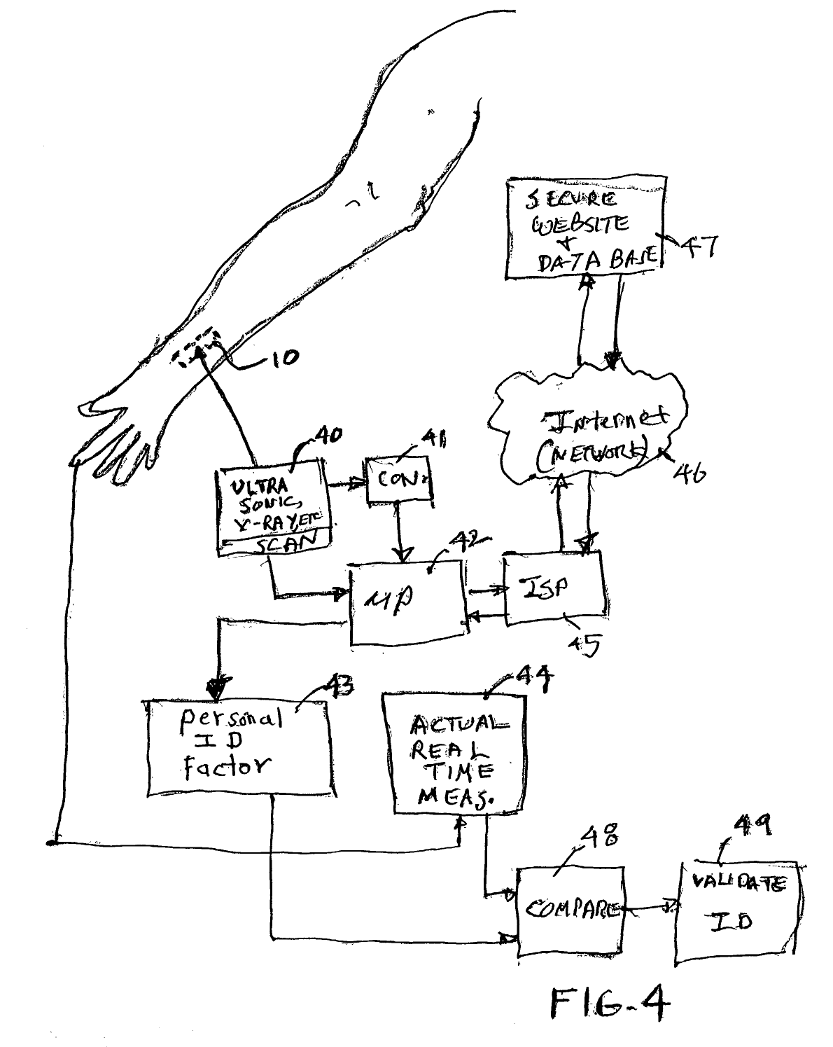

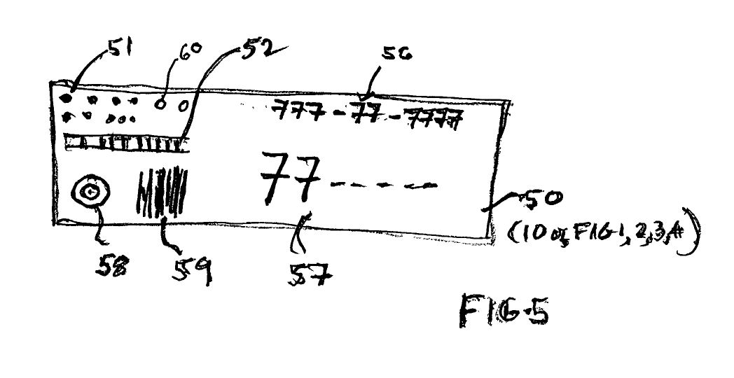

Referring to FIG. 4 there is shown another technique which can be utilized which makes the entire process simpler from the scanning point of view. In FIG. 4 again, the person appears at a desired identification area and the embedded biocompatible chip 10 is accessed by ultrasonic or x-rays and so on depicted by module 40 as described above. These are converted by converter 41 into a desired format, which may be an array of ones to zeros, or may be an actual photograph of the entire chip. In this particular manner, the person's social security number can be utilized as follows. The social security number can actually be placed on the embedded chip. As will be explained in conjunction with FIG. 5, it would be a simple procedure to take a photograph as an x-ray of the entire chip and the social security number of the person would immediately be visible. This number, again, is placed in the microprocessor. The microprocessor now converts the number to a desired format and the microprocessor accesses an Internet service provider 45 or some other means to access a network. In this matter, the ISP 45 accesses the Internet 46 and goes directly to a secure website and database 47. The website and database is maintained by governmental authorities and contains all information necessary and associated with that particular social security number. This information, for example, will be the voice print, retina scan, fingerprint, ear print and heart sounds of the individual or any other data, including the name, age, address of the individual, including a photograph of the individual. As can be seen, the remote website 47 can have unlimited storage means indicative of all individuals who have embedded cards 10. The storage site need only know the social security number of the individual, which is embedded on the chip and will then be transmitted to the identification location where all pertinent information concerning the individual as stored. This, of course, is shown transmitted through the internet 46 and through an ISP 45. It is, of course, understood that any network can be used to automatically access a common database such as telephone lines and so on.

In any event, the information now associated with the social security number is returned to the microprocessor 42, where the microprocessor 42 presents the personal ID factor as obtained from the secured website and database to the module 43. As described in FIG. 3, the person's fingerprint or other ID factor is then accessed to obtain the actual real-time measurement of the person's actual fingerprint as shown by module 44. This again is compared with the personal ID factor as stored at the website 47 and is indicated by the embedded biocompatible chip 10. This is again done by comparator 48 where the person is validated by the validate ID module 49. This is another technique of comparing information to ascertain the person's identification number. The security location does not have to process a complicated digital pattern which would be stored on the card. The problem with the above-noted procedure is that in theory it would be possible for someone to break into a secure website 47 and change the information and therefore, to make the information associated with a social security number false information. For example, a hacker knowing your social security number can now access the website 47 and place his ID information into the website. This is a very remote possibility, as one can ascertain there are numerous ways of securing the website 47 to prevent this from occurring. It is also fully known that the information conveyed over the internet 46 by the ISP is all encrypted and therefore one cannot gain access unless they have the encryption keys and so on. There are many ways of preventing the above-noted procedure from happening. It is, of course, noted that if the technique regarding FIG. 3 is utilized, then the possibility of circumventing the system is extremely remote, if not virtually impossible.

Referring to FIG. 5, there is shown a typical embedded chip 50 which contains various information. As shown by reference to numeral 51, the information can be a series of dots and blanks, which would be indicative of zeros and ones. The dots can be extremely small and for example, if one is using x-rays the dots can consist of small deposits of biocompatible metal on a x-ray transparent substrate, many of which are known, including silicon and other biocompatible materials. In this manner, the ones would be represented by extremely small dots of metal, which would show in a x-ray as very small dots. In this manner, the information can be processed by the converter by actually converting the dots into a picture, a histogram or whatever the manner as one can ascertain from the ordinary conversion of digital to analog information. Reference numeral 52 depicts another format of data storage where ones and zeros can be presented as small lines. FIG. 5 indicates that data can be presented by a series of concentric circles where, for example, the pattern shown by reference numeral 58 can represent any desired number. Other patterns, for example, four circles can represent other numbers. One can really ascertain reference numeral 59 shows a typical bar code which can be employed on the chip representing a large series of ones and zeros as, for example, present on the universal bar code which is well known and therefore, one can store numbers into the millions or billions by utilizing such data. Reference numeral 56 shows an actual social security number stored on the chip with the actual digits shown. If the chip 50 were scanned by an x-ray, one would see the actual social security number of the individual, which again can be processed by conventional optical processing equipment or can be entered into or can be viewed by the operator of the security system and punched into a keyboard and therefore, transferred to the network. For example, in that example, the social security number of an individual 56 would be imprinted in a metallic ink, such as the type of ink presented on bank checks. The x-ray would be totally responsive to the metal, as one can ascertain, the metal essentially absorbs rays and therefore one can see the metallic pattern. Therefore, the operator of the system would immediately, by accessing the chip, see the social security number as indicated by reference numeral 56 and then punch the social security number into the system by means of a keyboard. In this manner, the social security number would be presented to the secure website and the requisite data would be then transmitted to the ID location to be compared with the actual data of the individual. 57 shows that there is no limitation as to the size of the analog numbers if one wishes to utilize that data format. While ones and zeros can be represented, it is also understood that a metal substrate for chip 50 can have holes impressed thereon. These represent ones and zeros. The holes in the metal would appear as holes via a x-ray scan. Hence, it can be seen from FIG. 5 that there are a plurality of different data formats that can be utilized in conjunction with the biocompatible chip to enable a personal ID factor, which is stored on a chip to be compared with the actual ID factor which is inherent with the individual and therefore, indicative of the individual to enable a security location to present a reliable validation of the individual's ID.

It is understood that there are other techniques and various alternative solutions, which will be apparent to one skilled in the art, all of which are deemed to be in the spirit and scope of the claims as appended hereto.

What is claimed is:

1. A system for positive identification of an animal of a given species, said animal having predetermined characteristics capable of distinguishing any given animal from any other animal of said same species, comprising:
a biocompatible chip biologically coupled to said animal and containing stored data on said chip indicative of at least one predetermined characteristic of said animal capable of distinguishing said animal from other animals of said species,
means for reading said data on said chip to provide a replica of said characteristics and means for comparing said replica with the actual data characteristic of said animal as obtained from said animal in real-time to positively identify said animal by a favorable comparison of said chip data with said actual data.

2. The system according to claim 1 wherein said animal is a human of homosapien species.

3. The system according to claim 1 wherein said data includes at least one of the following:
at least one voice print, at least one retina scan, at least one fingerprint, at least one earprint, at least one heart sound and a social security number.

4. The system according to claim 3 wherein said data may also include information indicative of the person's name, age, photograph, credit rating and medical history.

5. The system according to claim 1 wherein said means for reading said data includes an x-ray, ultrasound and magnetic resonance.

6. The apparatus according to claim 2 wherein said means for reading includes means for obtaining a real-time actual representation of said characteristic from said animal at a given identification location for comparing said actual representation with said replica indicative of stored data.

7. The system according to claim 1 wherein said chip is embedded beneath the animal's skin.

8. The system according to claim 1 wherein said stored data is stored at least in one of the following formats:
as binary ones and zeros, in a coded format, bar code, analog information, a coded pattern and pixel patterns.

9. The apparatus according to claim 1 wherein said biocompatible material is selected from stainless steel, tantalum, semiconductor material and ceramic.

10. The apparatus for positive identification of a person at a security location by accessing a characteristic of said person for comparison with a characteristic uniquely identifying said person, comprising:
a biocompatible chip embedded within said person and containing stored data indicative of said characteristic,
means at said location for accessing said stored data and providing output indicia indicative of said stored data,
means at said location for accessing said actual data as indicative of said characteristic from said person,
means for comparing said actual data with said stored data at said location for validating the identity of said person upon a favorable comparison.

11. The apparatus according to claim 10 wherein said characteristic includes at least one of the following:
at least one fingerprint, one voice print, one ear print, one heart sound, one retina scan, a social security number, a pin number or combinations of the above.

12. The apparatus according to claim 1 wherein said means for accessing includes at least one of the following:
x-ray scan, ultrasound scan or infrared scan.

13. A system for positive identification of a human at a security site by accessing a unique characteristic of said human which distinguishes said human from other humans having the same characteristic and which characteristic uniquely identifies said human, comprising:
a biocompatible chip embedded within said human and containing stored data indicative of said characteristic,
means at said site for accessing said stored data to provide output indicia indicative of said stored data,
means responsive to said output indicia for accessing a remote database according to said stored data, said remote database containing stored information indicative of at least one other unique characteristic of said human,
means for transmitting said other stored unique characteristic for said database to said site,
means for accessing said human to provide said actual unique characteristic at said site,
means for comparing said actual characteristic with said other unique characteristic to validate the identity of said person upon a favorable comparison.

14. The system according to claim 13 wherein said database is accessed at an Internet website.

15. The system according to claim 1 wherein said means for comparing is implemented at said website.

16. The system according to claim 14 wherein said stored data on said chip is selected from at least said human's social security member, an individual pin number or a personal individual code.

17. The system according to claim 16 wherein said stored data is inputted at said site to access said Internet website.

18. The system according to claim 17 wherein said data transmitted between said site and said website is encrypted.

19. The system according to claim 13 wherein said means for accessing stored data includes at least one of the following:
x-ray, ultrasound NMR, infrared or a combination of the above.

20. A method for the positive identification of a human by accessing at least one of a number of unique characteristics of said human where each characteristic uniquely identifies said human as compared to other humans, comprising the steps of:
implanting a biocompatible chip within said human, said chip containing stored data indicative of at least one of said unique characteristics,
accessing said stored data at a security site,
checking said unique characteristic from said human at said site,
comparing said stored data with said derived data for positively identifying said human upon favorable comparison.

21. The method according to claim 20 wherein said unique characteristic includes at least one of the following:
a finger print, a voiceprint, a retina scan, heart sounds, ear print or a combination of the above.

22. The method according to claim 20 wherein said stored data includes at least one of the following:
a personal identification number (PIN) or a social security number.

23. The method according to claim 22 further including the steps of:
accessing said stored member at said site,
transmitting said stored member to a remote database having shared therein unique characteristics of said human,
transmitting at least one of said unique characteristics to said site, and
comparing said transmitted characteristics to said derived data for positively identifying said human.

24. The method according to claim 23 further including the steps of:
providing a website accessible via a network for containing said remote database.

25. The method according to claim 24 wherein said network is the Internet.

26. The method according to claim 25 wherein said transmission to and from said remote database is encrypted.

27. A system for recognizing the identity of an individual comprising:
a module embedded on the body of an individual, which contains information associated with the individual,
a means for acquiring the information from the module,
a means for collecting information from the individual regarding actual physical characteristics of the individual, and
a means for comparing the two forms of information to identify the individual.

28. A method of recognizing the identity of an individual comprising:
embedding on the body of the individual a module containing information associated with the individual;
acquiring the information from the module;
collecting information from the individual regarding actual physical characteristics of the individual; and
comparing the two forms of information to identify the individual.

29. An identification module comprising:
a device that can be embedded on the body of an individual and data associated with the individual which is stored on the device, which data can be acquired from the device for a comparison with actual physical data gathered from the individual, in order to identify the individual.
